(19) United States
(12) Patent Application Publication
(10) Pub. No.: US 2015/0088582 A1
(43) Pub. Date: Mar. 26, 2015

(54) SUSTAINABILITY CAMPUS OF CO-LOCATED FACILITIES

(71) Applicant: Enginuity Worldwide, LLC, Mexico, MO (US)

(72) Inventors: Chad SAYRE, Mexico, MO (US); Robert L. Heimann, Mexico, MO (US); Nancy Heimann, Mexico, MO (US)

(21) Appl. No.: 14/556,445

(22) Filed: Dec. 1, 2014

Related U.S. Application Data
(63) Continuation of application No. 13/018,219, filed on Jan. 31, 2011.
(60) Provisional application No. 61/337,021, filed on Jan. 29, 2010.

(51) Int. Cl. G06Q 10/06

(52) U.S. Cl. CPC G06Q 10/06313
USPC 705/7.23

(57) ABSTRACT

A system and method for energy use is provided that includes a sustainability campus of co-located facilities, with associated facilities such as an energy development center, a source, and a processing or collection facility. The sustainability campus incorporates design principles and processes to decrease environmental impact per unit energy usage, increase waste reuse within the sustainability campus, and increase the receipt of financial credits.

### CROSS REFERENCE TO RELATED APPLICATIONS

This application is a continuation of application Ser. No. 13/018,219, filed Jan. 31, 2011, which claims the benefit of the filing date under 35 U.S.C. §119(e) of Provisional U.S. Patent Application Ser. No. 61/337,021, entitled “Improved Business Systems for Energy”, filed Jan. 29, 2010, the contents of which are incorporated herein by reference in their entirety and continued preservation of which is requested.

### FIELD

The present disclosure generally relates to efficient energy use, and more particularly to facilities utilizing green technologies and alternative energy technologies to decrease greenhouse gas emissions, decrease energy losses, increase waste reuse, and increase financial credits.

### BACKGROUND

Twenty-first century industries such as advanced manufacturing and data centers commonly require access to large capacities of electric power, and access to green power that can be produced at a competitive cost. Continued increases in electricity consumption have sparked desires to find agricultural solutions to energy needs.

Several crops have found technical feasibility to generate fuels, such as soybeans, corn, and algae. However, economic successes are harder to find. These circumstances contribute to sense of urgency to find a more cost effective and technically feasible approach to agriculturally-based energy sources. Although biomass processing capacity has increased in recent times, there is a local, regional and national need to further expand that capacity and to more efficiently direct the use of that capacity, so as to reduce energy losses and waste.

Additionally, the emphasis on reducing dependence on fossil fuels and a reduction in greenhouse gas emissions is more evident than ever before. Furthermore, consumers desire energy sources with favorable emissions profiles.

Moreover, long term, decentralized power production is gaining acceptance and preference. Consumers desire independence from legacy power grids through obtaining power from their own sources or from local, self-sufficient energy sources with favorable emissions profiles.

### SUMMARY

In one form, a system for energy use is provided that comprises a sustainability campus of co-located facilities that either are contiguously co-located or are in operational proximity and additionally under at least one of a commonly operated unit or a commonly designed unit. The co-located facilities comprise an energy production facility configured to produce energy, at least one consumption center configured to receive energy from the energy production facility, at least one development center configured to perform one of receiving energy from the energy production facility or producing energy, a waste center configured to receive waste produced via operation of the sustainability campus, and to utilize the waste for at least one of food or energy production within the sustainability campus, and a plurality of processing and collection facilities that process fuels for the energy production facility, the plurality of processing and collection facilities being regionally located, wherein operational proximity is defined as a geographic area that allows for economically viable logistics, and wherein contiguously co-located refers to land units, allocated specifically for particular facilities that are in physical contact with one another.

In another form, a method for energy use is provided that comprises obtaining biomass from a biomass source, the biomass having a biomass composition, processing the biomass, receiving the biomass at an energy production facility, the energy production facility being one of co-located facilities within a sustainability campus, or being adjacent to the sustainability campus, the co-located facilities being either contiguously co-located or in operational proximity and additionally under at least one of a commonly operated unit or a commonly designed unit, producing energy via the biomass compact at the energy production facility, powering at least one consumption center and at least one development center with the energy produced at the energy production facility, the at least one consumption center and the at least one development center being among the co-located facilities within the sustainability campus, sending waste produced within at least one of the sustainability campus or the energy production facility to a waste center, the waste center being one of the collocated facilities within the sustainability campus, reusing the waste within the sustainability campus, and processing fuels for the energy production facility at a plurality of processing and collection facilities that are regionally located, wherein operational proximity is defined as a geographic area that allows for economically viable logistics, and wherein contiguously co-located refers to land units, allocated specifically for particular facilities that are in physical contact with one another.

In another form, the present disclosure a method for energy use is provided that comprises producing energy at least one energy production facility, the energy production facility being one of co-located facilities within a sustainability campus, the co-located facilities being either contiguously co-located or in operational proximity and additionally under at least one of a commonly operated unit or a commonly designed unit, powering at least one consumption center, the consumption center being one of the co-located facilities within the sustainability campus, identifying sources and determining an amount of greenhouse gases released into the atmosphere due to at least one of agricultural sources or operation of facilities located within the sustainability campus, processing fuels for the energy production facility at a plurality of processing and collection facilities that are regionally located, and increasing receipt of at least one of tax credits, energy coupons, vouchers, product credits, or carbon credits, for participants of the sustainability campus by offsetting the greenhouse gases released into the atmosphere with reductions in greenhouse gas emissions by using green technologies, and due to contiguous colocation of the at least one energy production facility and the at least one consumption center within the sustainability campus, reducing energy line loss and increasing waste recapture, wherein operational proximity is defined as a geographic area that allows for economically viable logistics, and wherein contiguously co-located refers to land units, allocated specifically for particular facilities that are in physical contact with one another.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating a layout and function of a sustainability campus in accordance with the principles of the present disclosure;

FIG. 2 is a flow chart illustrating a method for enhancing a greenhouse gas emissions profile and obtaining financial credits in accordance with the principles of the present disclosure; and

FIG. 3 is a flow chart illustrating a method for waste management in accordance with the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

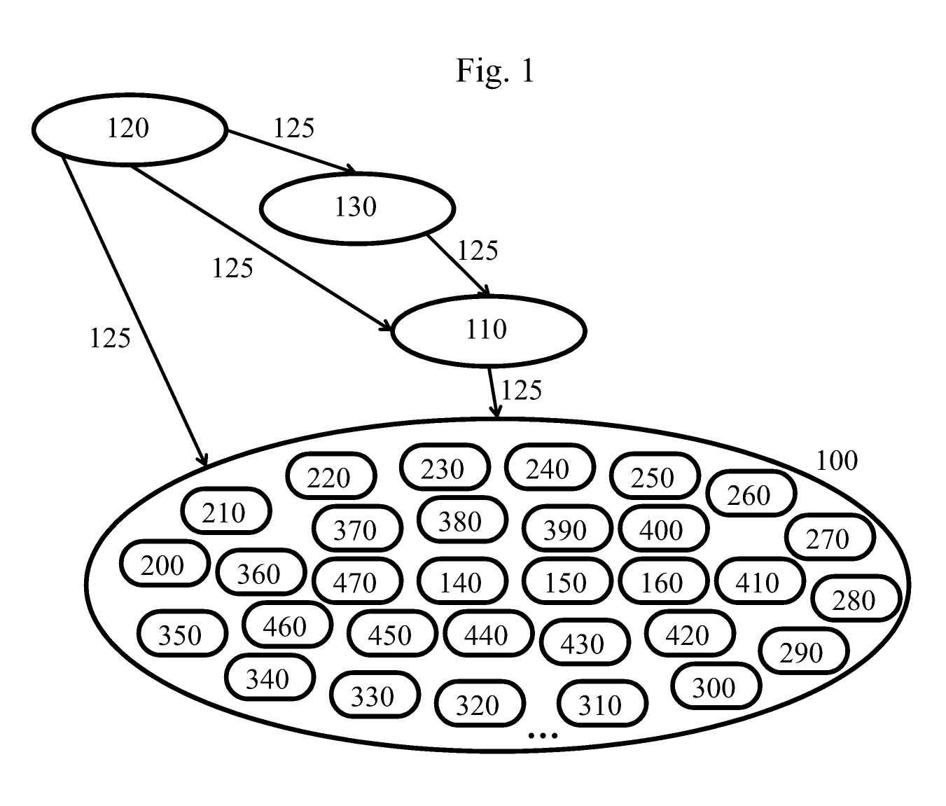

Referring to FIG. 1, a sustainability campus of co-located facilities in accordance with the teachings of the present disclosure is illustrated and generally indicated by reference numeral 100. In conjunction with associated facilities such as an energy production facility 110, a source 120, and a processing or collection facility 130, the sustainability campus 100 incorporates physical design principles and business processes to increase the receipt of financial credits, decrease environmental impact per unit energy usage, and increase waste reuse within the sustainability campus 100. The energy production facility 110, the source 120, and the processing or collection facility 130 may each be located within or adjacent to the sustainability campus 100, or within the same city, county, or state as, up to about 100 kilometers distant, or up to about 200 kilometers distant from the sustainability campus 100. Alternative forms of the present disclosure may include a plurality of sustainability campuses 100, a plurality of energy production facilities 110, a plurality of sources 120, and/or a plurality of processing or collection facilities 130.

As used herein, the term “co-located” is defined as facilities located in operational proximity, and additionally under at least one of a commonly operated unit and/or a commonly designed (planned or developed) unit. The term “operational proximity” is defined as a geographic area that allows for economically viable logistics, such as transportation, piping, and power distribution, among others. The term “contiguously co-located” is defined herein as land units, allocated specifically for particular facilities that are in physical contact with one another. For example, if the land allocated for facility A is in physical contact with the land allocated for facility B, then facility A and facility B are contiguously co-located. Three facilities A, B, and C form a contiguously co-located bloc if, for example, the land allocated for structure A is in physical contact with the land allocated for structure B, and the land allocated for structure B is in physical contact with the land allocated for structure C. The term “adjacent” is defined herein as being located on land units or zones that are located next to one another.

Located within the sustainability campus 100 is a plurality of co-located facilities. In one form, the co-located facilities emphasize 21^{st} century technologies, including energy consumers 140, manufacturing centers 150, and energy development centers 160. In another form, the energy consumers 140, manufacturing centers 150, and energy development centers 160 may each form their own contiguous blocs in the sustainability campus, e.g. an energy consumer bloc (all the energy consumers may be located in one contiguous bloc), a manufacturing bloc, or an energy development bloc. In an alternative form, the individual facilities among the energy consumers 140, manufacturing centers 150, and energy development centers 160 may not be limited to locations in particular blocs, such that individual energy consumers, individual manufacturing centers, or individual energy production facilities may be scattered and intermingled throughout the sustainability campus 100.

In one form, all facilities located within and associated with the sustainability campus 100 are kept adjacent or in close proximity to one another, so as to reduce or minimize costs, reduce or minimize energy line losses, and increase or maximize recapture of waste products, including tempered water, ashes, carbon sources, and biogases. The associated facilities include the energy production facility 110, the source 120, and the processing or collection facility 130.

Particularly, the co-located facilities within the sustainability campus 100 may include, for example, one or more of a data processing center 200, computing center 210, solar energy production facility 220, plating facility for next generation batteries 230, wind energy production facility 240, natural gas production facility 250, cloud computing data management facility 260, 21^{st} century education center 270, recycling center 280, plastic production facility 290, biomass fuel energy production facility 300, biomass use center 310, heat reuse center 320, waste reuse center 330, waste reclamation center 340, pellet manufacturing center 350, briquette manufacturing center 360, algae production or processing center 370, geothermal energy production facility 380, methane-fueled combustion facility 390, extension manufacturing and technology development center 400, aqua center 410, food production facility 420 using hydroponics, horticulture facility 430, landfills 440, hydrogen power facility 450, livestock feed centers 460, and an agricultural power production center 470. It should be understood that these co-located facilities are merely exemplary and should not be construed as limiting the scope of the present disclosure. Therefore, other facilities not listed herein, which would accommodate operation of the sustainability campus 100 in accordance with the teachings herein shall be construed as falling within the scope of the present disclosure.

The sustainability campus 100 may contain any combination of these co-located facilities, including more than one of any one type of facility. Additionally, any of these individual facilities can be classified under one or more than one of the energy consumers 140 if they consume energy, manufacturing centers 150 if they manufacture or produce any products, or energy development centers 160 if they produce energy. In one form, the energy production facility 110 or any of the energy development centers 160 may or may not use backup battery energy storage.

The source 120 may provide fuel 125, wherein the fuel 125 may for example be one or a mixture of biomass, forage, a forest product, natural gas, coal dust, starch, algae, duckweed, biogas from a landfill, biogas from a biomass, woods, wood waste, grass, canes, sprouts, cakes, coal and coal products, yard waste, crop waste and byproducts, wind, or solar energy.

The source 120 may for example be a conservation site, a reserve, the Conservation Reserve Program, the Wildlife Reserve Program, a marginal land, a nonproductive land, a park, an urban yard, an agricultural crop field, a food processing plant, or a land in government-managed or government-contracted land use program, among others. Another form may involve developing estimates of potential new areas of energy sourcing lands that are not currently in production of food products. In an alternative form, a plurality of sources 120 may provide fuels 125.

Source 120 management may encompass development of a statewide resource development plan for underutilized sources of, for example, agricultural biomass, woods, forages, duckweed, algae, and all the other listed fuel sources. Source 120 management may further relate to the creation or enhancement of existing systems and methods of collection, marketing, and trading of biomass products, by use of a cooperative effort between sources 120 and other associated parties, and though business structures that emphasize market access e.g. the establishment of conditions for the entry of goods on the market. Source 120 management may further promote the expansion of growing season, expansion of acceptable species for growing areas, and/or the expansion of regions acceptable for raising economically viable crops. For example, as an improvement over conventional seasonal crops, the development of new “twelve month” forage crops and biomass markets of agricultural products, which due to development and marketing techniques may be available year-round. Source 120 management may also encompass farmers and ownerships harvesting and collecting existing forage materials and planting new crops of woods, canes, algae, forages, and other fuels 125.

In one form, the source 120 may send the fuel 125 to a processing or collection facility 130, which processes or collects the fuel 125 for use at the energy production facility 110 or any of the energy development centers 160. Once there, the fuel 125 may be utilized for energy, for example by undergoing combustion. In another form, a plurality of processing and collection facilities 130 may process fuels 125, and may be regionally located. In an alternative form, the source 120 may directly provide processed or unprocessed fuel 125 to the energy production facility 110 or any of the energy development centers 160. In a further form, some of the fuels 125, processed or unprocessed, may be placed on a commercial product market.

In a specific form, one or more of the co-located facilities in the sustainability campus 100 may operate on energy received solely from within the sustainability campus 100, or solely from the energy produced at the energy production facility 110 and/or the energy development centers 160. In a particular form, the energy produced by the energy production facility 110 and/or the energy development centers 160 may provide energy independence to small, remote, or regional areas, or clusters of agribusiness operations, eliminating the need for access to legacy electrical power grids and resulting in the decentralization of power distribution. In another form, the use of the processes allows for a facility to generate electrical power to place on the legacy electrical power grid.

In one form, wind power may be harvested using windmills or wind turbines optionally supplemented with photovoltaic cells in the ground level area around the base of the windmill or wind turbine. In another form, the base or pillar of the wind turbine structure may optionally incorporate air pressure vessels, which aid in overcoming the torque of start-up, or serve as exhaust for jet turbines. In another form, wind turbines are co-located to capture extra wind energy and can thus be spun with supplemental energy.

The fuel processing may for example involve receiving, separation, processing, and manufacturing, and may for example convert the fuel 125 into biomass compacts, pellets, briquettes, and gases. The fuel processing may also or alternatively involve collection and compaction of fuel 125 comprising agricultural biomass into forms of bales, bags, cakes, bundles, rolls, bricks, and blocks. The fuel processing may also encompass dewatering of biomass to make it transportable, or extraction of oil from the biomass.

All forms of transportation may be used to transport the fuels and products between the source 120, the processing or collection facility 130, the energy production facility 110, and the sustainability campus 100, and between the co-located facilities within the sustainability campus 100. In a particular form, vehicles and other transportation methods may utilize hybrid technology, electric-powered engines, and other green engine designs. Transportation methods may also involve reducing transmit time and distance between facilities by design of direct routes and roads, and by a comprehensive rail system. Transportation methods may favor the use of ethanol, biodiesel, biofuel, and other green fuels.

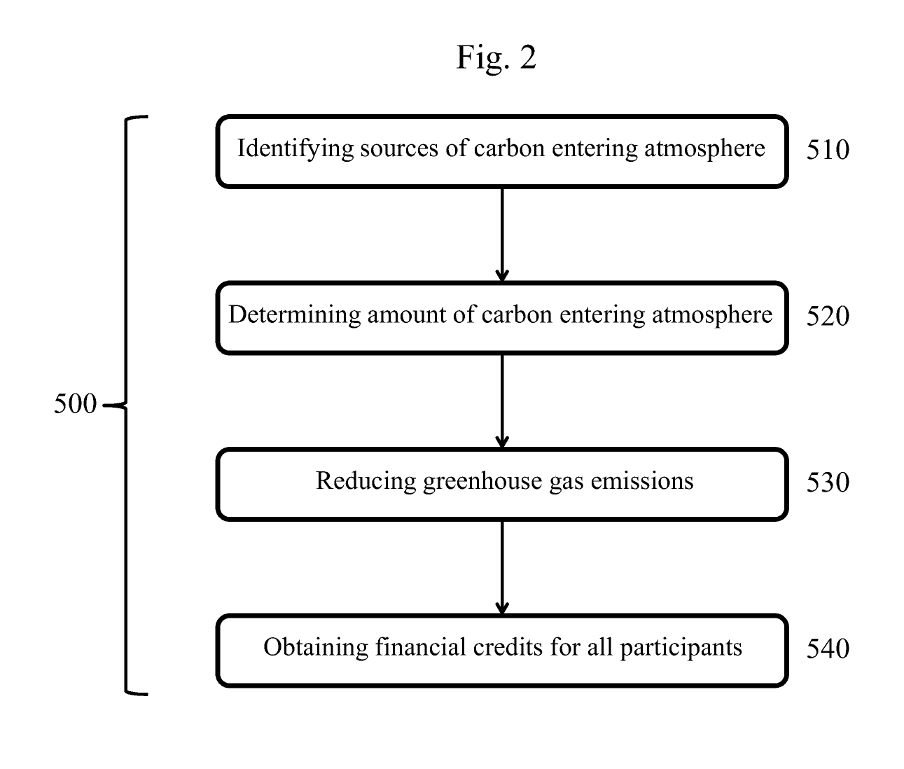

Referring to FIG. 2, the present disclosure further relates to a method 500 of reduction of greenhouse gas emissions and enhancement of financial credits, accomplished through a cooperative effort between participants and facilities associated with and within the sustainability campus 100.

Particularly, the present disclosure involves identifying sources 510 and determining an amount 520 of greenhouse gases released into the atmosphere due to one or more source 120 e.g. an agricultural source, or due to operation of facilities located within or associated with the sustainability campus 100. The greenhouse gases are, for example, carbon dioxide, water vapor, methane, and nitrous oxide. The determination of the amount of greenhouse gases released may incorporate which gases were not captured or accounted for, and may involve developing a quantitative measure, for example the mass of carbon released. The agricultural sources causing greenhouse gas emissions may include both natural and unnatural means, for example burning of conservation reserve programs, wildlife reserve programs, pastures, forested areas, and wood waste incinerators.

The greenhouse gases released are offset by greenhouse gas emission reductions 530, which are achieved through the use of green technologies, and due to co-location or contiguous co-location of and due to contiguous co-location the facilities associated with and within the sustainability campus 100, which reduces energy line loss and increases waste recapture. The use of green technologies may involve utilizing fuels produced from plant materials that sequester carbon during their growth, while producing oxygen. Because of this carbon trapping, the fuels produced from these materials are classified as “carbon neutral.” The use and reuse of biomass waste also results in an improved environmental footprint, without air quality hazards. Additionally, the use of the biomass mixtures and compacts described in concurrently filed applications “Composite Biomass Fuel Compact” and “Biomass Fuel Compact Processing Method,” which are commonly assigned with the present application and incorporated herein by reference in their entirety, yields an improved burning medium that enhances the regulated or unregulated emissions profile, particularly through reduction of greenhouse gas emissions.

The favorable ratio between greenhouse gas released and greenhouse gas reductions, in addition to the use of green technologies eligible for government subsidies, results in increased receipt of financial credits 540, including state and federal tax credits, agricultural tax credits, energy coupons, vouchers, electric vouchers, product credits, and carbon credits, to participants and facilities within and associated with the sustainability campus 100. The use of “carbon neutral” materials, for example, results in state and federal tax credits, and exemptions from carbon tariffs.

The present disclosure also relates to waste management and sustainable energy practices at the sustainability campus 100. Waste generated within the sustainability campus 100 is processed for reuse. In one form, the close proximity of energy consumers 140 and energy development centers 160 and the energy production facility 110 increases or maximizes recapture of waste products, including warm wastewater, ashes, carbon sources, and biogases. In another form, the thermal content of these waste products may be repurposed.

In one form, wastewater treatment material handling methods are used to harvest, handle, and otherwise manage wastewater resulting from biomass that is being produced for renewable energy for the sustainability campus 100, or resulting from any other activities on the sustainability campus 100. Further, warm wastewater sources are co-located with sites and facilities utilizing the thermal content of the warm wastewater.

In another form, one or more of the co-located facilities in the sustainability campus 100, for example the aqua center 410, algae production or processing center 370, food production facility 420, or horticulture facility 430, and/or one or more sources 120 may be co-located with one or more energy consumers 140. The aqua center 410 manages water distribution throughout the sustainability campus 100, and optionally functions as a central warm waste water distribution center.

In one form, one or more of the energy consumers 140, such as the data processing center 200 or the computing center 210, utilize wastewater as a cooling medium. In a separate form, the wastewater is deployed through a landfill 440 with appropriate bacteria to produce methane gas. The methane gas can then fuel hydrogen production at the hydrogen power production facility 450 via electrolysis of water or bio-reaction of biomass. The wastewater source may be located adjacent to the landfill 440 and the aqua center 410. In an alternative form, the wastewater, optionally the last remnants of wastewater, may irrigate hay, grass crop, seasonal field or produce crops, optionally combined for example with compost generated by the aqua center 410. In yet another form, wastewater, optionally the entire quantity generated, is returned for production or use at the sustainability campus 100. In another form, the aqua center 210 uses energy produced, for example, by the solar power production facility 220, hydrogen power production facility 450, or any other energy development centers 160, or energy from fossil fuels, to augment the latent energy in the wastewater to achieve target thermal loads. In another form, the warm wastewater is a feedstock in the production of steam.

In another form, biomass is recycled onsite at the sustainability campus 100 into energy for drying and processing, for capture of flue gas and fly ash, for reincorporation into products, or for sequestration and sparging into lagoons for uptake by aquatic life such as duckweed, or for recapture or recycling of combustion ash and residue into pellets for use as fertilizer, or for return of inorganics to the soil, or as fillers for concrete or asphalt. In another form, post combustion waste products can be added to animal feeds as trace mineral source.

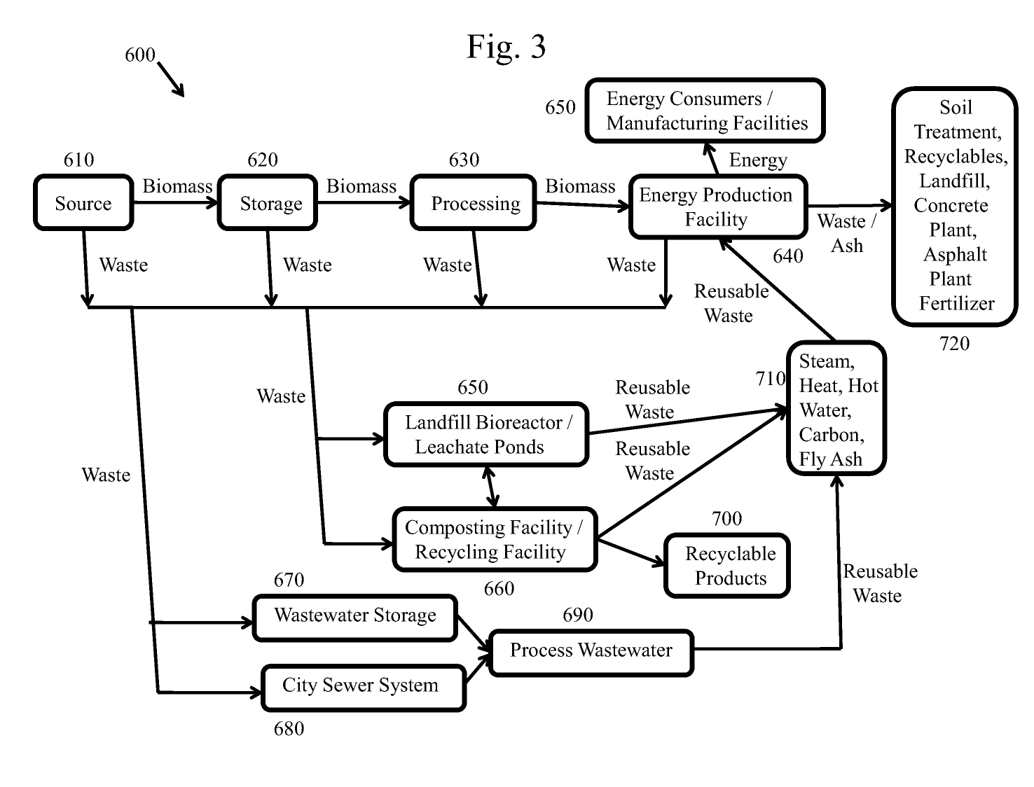

Referring to FIG. 3, a specific form of a method for waste management 600 is presented. Biomass originates at a source 610, and passes through storage 620 and processing 630 until it reaches an energy production facility 640. There, the energy produced is used to power energy consumers and manufacturing facilities 650. However, waste produced at the source 610, storage 620, processing 630, and energy production facility 640 are repurposed to landfill bioreactors and leachate ponds 650, and composting and recycling facilities 660. The waste is also sent to wastewater storage 670 and a city sewer system 680, and undergoes wastewater processing 690. The waste is processed into usable waste. Some of the usable waste is used to produce recyclable products 700, while some or all of the remaining waste is returned in the form of steam, heat, hot water, carbon, or fly ash 710 to the energy production facility 640. Some of the waste/ash produced by the energy production facility 650 is also used for soil treatment, recyclables, landfills, concrete plants, asphalt plants, and plant fertilizer 720.

It should be noted that the invention is not limited to the various forms described and illustrated as examples. A large variety of modifications have been described and more are part of the knowledge of the person skilled in the art. These and further modifications as well as any replacement by technical equivalents may be added to the description and figures, without leaving the scope of the protection of the invention and of the present patent.

What is claimed is:

1. A system for energy use, comprising:
a sustainability campus of co-located facilities that either are contiguously co-located or are in operational proximity and additionally under at least one of a commonly operated unit or a commonly designed unit; the co-located facilities comprising:
an energy production facility configured to produce energy;
at least one consumption center configured to receive energy from the energy production facility;
at least one development center configured to perform one of receiving energy from the energy production facility or producing energy;
a waste center configured to receive waste produced via operation of the sustainability campus, and to utilize the waste for at least one of food or energy production within the sustainability campus; and
a plurality of processing and collection facilities that process fuels for the energy production facility, the plurality of processing and collection facilities being regionally located,
wherein operational proximity is defined as a geographic area that allows for economically viable logistics; and
wherein contiguously co-located refers to land units, allocated specifically for particular facilities that are in physical contact with one another.

2. The system according to claim 1, further comprising a plurality of consumption centers, at least one of the plurality of consumption centers being a computing center.

3. The system according to claim 1, wherein the at least one consumption center operates on energy received solely from within the sustainability campus.

4. The system according to claim 1, wherein the waste center is a waste water distribution center, the waste is water, and thermal content of the water aids in the at least one of food or energy production within the sustainability campus.

5. The system according to claim 1, wherein the at least one development center comprises a solar power production facility.

6. The system according to claim 1, wherein the at least one development center comprises a wind power production facility.

7. The system according to claim 1, wherein the at least one development center comprises a natural gas power production facility.

8. The system according to claim 1, wherein the at least one development center is a methane-fueled combustion facility.

9. The system according to claim 1, wherein the at least one development center comprises a geothermal power production facility.

10. The system according to claim 1, wherein the energy production facility is configured to produce energy from biomass fuels, the biomass fuel being produced from raw biomass at a biomass processing center located no further than 100 kilometers from the sustainability campus.

11. The system according to claim 1, wherein the sustainability campus is configured to increase receipt of at least one of federal tax credits, state tax credits, energy coupons, vouchers, product credits, or carbon credits, to participants of the sustainability campus.

12. A method for energy use, comprising the following steps:
obtaining biomass from a biomass source, the biomass having a biomass composition;
processing the biomass;
receiving the biomass at an energy production facility, the energy production facility being one of co-located facilities within a sustainability campus, or being adjacent to the sustainability campus; the co-located facilities being either contiguously co-located or in operational proximity and additionally under at least one of a commonly operated unit or a commonly designed unit;
producing energy via the biomass compact at the energy production facility;
powering at least one consumption center and at least one development center with the energy produced at the energy production facility, the at least one consumption center and the at least one development center being among the co-located facilities within the sustainability campus;
sending waste produced within at least one of the sustainability campus or the energy production facility to a waste center, the waste center being one of the collocated facilities within the sustainability campus;
reusing the waste within the sustainability campus; and
processing fuels for the energy production facility at a plurality of processing and collection facilities that are regionally located, wherein operational proximity is defined as a geographic area that allows for economically viable logistics; and
wherein contiguously co-located refers to land units, allocated specifically for particular facilities that are in physical contact with one another.

13. The method of claim 12, further comprising the following steps:
determining an amount of the carbon entering atmosphere that is not recaptured, due to at least one of agricultural sources or operation of the sustainability campus; and
developing a carbon offset credit by reducing carbon emissions from the sustainability campus to offset the carbon entering the atmosphere.

14. The method of claim 12, wherein the biomass source is one of a conservation site, reserve, marginal land, nonproductive land, park, urban yard, agricultural crop field, food processing plant, or land in government-managed or government-contracted land use program.

15. The method of claim 12, wherein the energy production facility is no further than 200 kilometers from the sustainability campus.

16. The method of claim 12, wherein the biomass is classified as a carbon neutral material.

17. The method of claim 12, further comprising redirecting thermal content of the waste to facilities within the sustainability campus.

18. The method of claim 12, wherein the waste includes at least one of tempered water, ashes, a carbon source, or a biogas.

19. The method of claim 12, further comprising co-locating the energy production facility, the at least one consumption center, and the at least one development center to form a contiguously adjacent bloc, thereby reducing energy line losses and increasing recapture of waste.

20. A method for energy use, comprising the following steps:
producing energy at least one energy production facility, the energy production facility being one of co-located facilities within a sustainability campus;
the co-located facilities being either contiguously co-located or in operational proximity and additionally under at least one of a commonly operated unit or a commonly designed unit;
powering at least one consumption center, the consumption center being one of the co-located facilities within the sustainability campus;
identifying sources and determining an amount of greenhouse gases released into the atmosphere due to at least one of agricultural sources or operation of facilities located within the sustainability campus;
processing fuels for the energy production facility at a plurality of processing and collection facilities that are regionally located; and
increasing receipt of at least one of tax credits, energy coupons, vouchers, product credits, or carbon credits, for participants of the sustainability campus by offsetting the greenhouse gases released into the atmosphere with reductions in greenhouse gas emissions by using green technologies, and due to contiguous colocation of the at least one energy production facility and the at least one consumption center within the sustainability campus, reducing energy line loss and increasing waste recapture;
wherein operational proximity is defined as a geographic area that allows for economically viable logistics; and
wherein contiguously co-located refers to land units, allocated specifically for particular facilities that are in physical contact with one another.
